(19) United States
(12) Patent Application Publication
(10) Pub. No.: US 2017/0133130 A1
(43) Pub. Date: May 11, 2017

(54) COAXIAL CABLE WITH THIN CORRUGATED OUTER CONDUCTOR AND METHOD OF FORMING SAME

(71) Applicant: CommScope Technologies LLC, Hickory, NC (US)

(72) Inventors: Frank A. Harwath, Naperville, IL (US); Scott M. Adams, Catawba, NC (US); James P. Fleming, Orland Park, IL (US); Jeffrey D. Paynter, Momence, IL (US)

(21) Appl. No.: 15/299,520

(22) Filed: Oct. 21, 2016

Related U.S. Application Data
(60) Provisional application No. 62/251,520, filed on Nov. 5, 2015.

(51) Int. Cl. H01B 13/016; H01B 7/02

(52) U.S. Cl. CPC H01B 13/016; H01B 7/02

(57) ABSTRACT

A method of manufacturing a coaxial cable includes: providing an intermediate construction for a coaxial cable comprising an inner conductor, a dielectric layer circumferentially surrounding the inner conductor, and a smooth outer conductor circumferentially surrounding and adhered to the dielectric layer; and impressing corrugations into the outer conductor and corresponding protrusions in the dielectric layer.

### RELATED APPLICATION

The present application claims priority from and the benefit of U.S. Provisional Patent Application No. 62/251,520, filed Nov. 5, 2015, the disclosure of which is hereby incorporated herein in its entirety.

### FIELD OF THE INVENTION

The present invention relates generally to cable, and more specifically to coaxial cable.

### BACKGROUND

Coaxial cable typically includes an inner conductor, an outer conductor, a dielectric layer that separates the inner and outer conductors, and a jacket that surrounds the outer conductor. The outer conductor can take many forms, including flat, braided, and corrugated.

A typical corrugated outer conductor is manufactured by welding a thin wall cylindrical tube from a flat strip. This tube is then formed into a corrugated outer conductor with a specific shape by using use of one of several available forming methods. A typical shape for an outer conductor 1010 of a corrugated cable 1000 is shown in FIGS. 1 and 2. The thickness of the outer conductor 1010 is typically greater than 0.007 inch (even in relatively small cables) due to manufacturing limitations (particularly for reliable welding of the seam) and mechanical strength requirements for bending, crush and tensile loading. The corrugated outer conductor 1010 is then slipped over a dielectric layer 1014 that has already been extruded over an inner conductor (see FIG. 2).

While the illustrated corrugation shape is relatively easy to make and results in a cable with adequate bending performance, it may be desirable to further improve on the design and to reduce the metal content of the cable without sacrificing cable bending performance.

### SUMMARY

As a first aspect, embodiments of the invention are directed to a method of manufacturing a coaxial cable. The method comprises: providing an intermediate construction for a coaxial cable comprising an inner conductor, a dielectric layer circumferentially surrounding the inner conductor, and a smooth outer conductor circumferentially surrounding and adhered to the dielectric layer; and impressing corrugations into the outer conductor and corresponding protrusions in the dielectric layer.

As a second aspect, embodiments of the invention are directed to a coaxial cable, comprising: an inner conductor; a dielectric layer circumferentially surrounding the inner conductor; an outer conductor circumferentially surrounding the dielectric layer, the outer conductor having a thickness of less than 0.065 inch. The outer conductor has corrugations and the dielectric layer has protrusions that fill the corrugations.

As a third aspect, embodiments of the invention are directed to a coaxial cable, comprising: an inner conductor; a foamed dielectric layer circumferentially surrounding the inner conductor; and an outer conductor circumferentially surrounding the dielectric layer. The outer conductor has corrugations and the dielectric layer as protrusions that fill the corrugations. The dielectric layer has a density gradient that increases with radial distance from the inner conductor.

As a fourth aspect, embodiments of the invention are directed to a coaxial cable, comprising: an inner conductor; a dielectric layer circumferentially surrounding the inner conductor; and an outer conductor circumferentially surrounding the dielectric layer, the outer conductor having a thickness of less than 0.065 inch. The outer conductor has impressed dimples.

### BRIEF DESCRIPTION OF THE FIGURES

FIG. 1 is a side view of a corrugated outer conductor of a prior art coaxial cable.

FIG. 2 is a section view of the outer conductor of FIG. 1 within a portion of a coaxial cable.

FIG. 3 is a section view of an intermediate construction of a dielectric layer and smooth outer conductor according to embodiments of the invention.

FIG. 4 is a section view of the construction of FIG. 3 after the outer conductor and the dielectric layer have been corrugated to form a coaxial cable.

FIG. 5 is a section view of a coaxial cable according to alternative embodiments of the invention.

FIG. 6a-6e are perspective views of outer conductors of coaxial cables according to further embodiments of the invention.

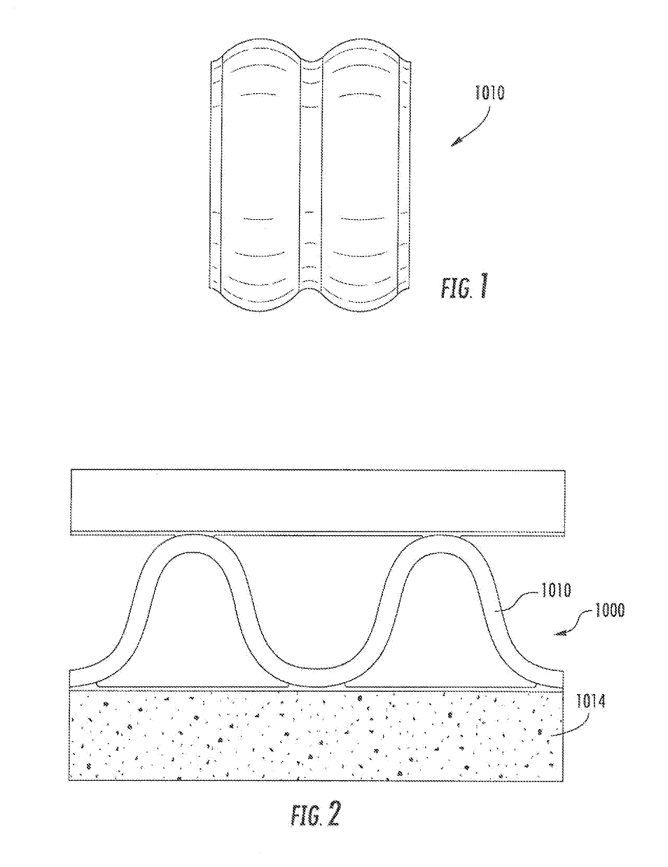

### DETAILED DESCRIPTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Unless otherwise defined, all technical and scientific terms that are used in this disclosure have the same meaning as commonly understood by one of ordinary skill in the art to which this invention belongs. The terminology used in the above description is for the purpose of describing particular embodiments only and is not intended to be limiting of the invention. As used in this disclosure, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

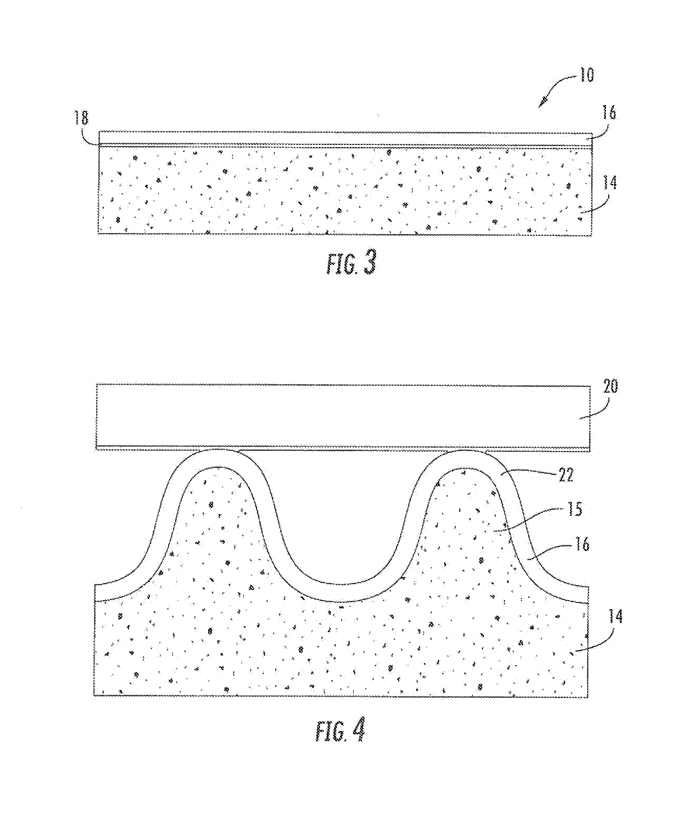

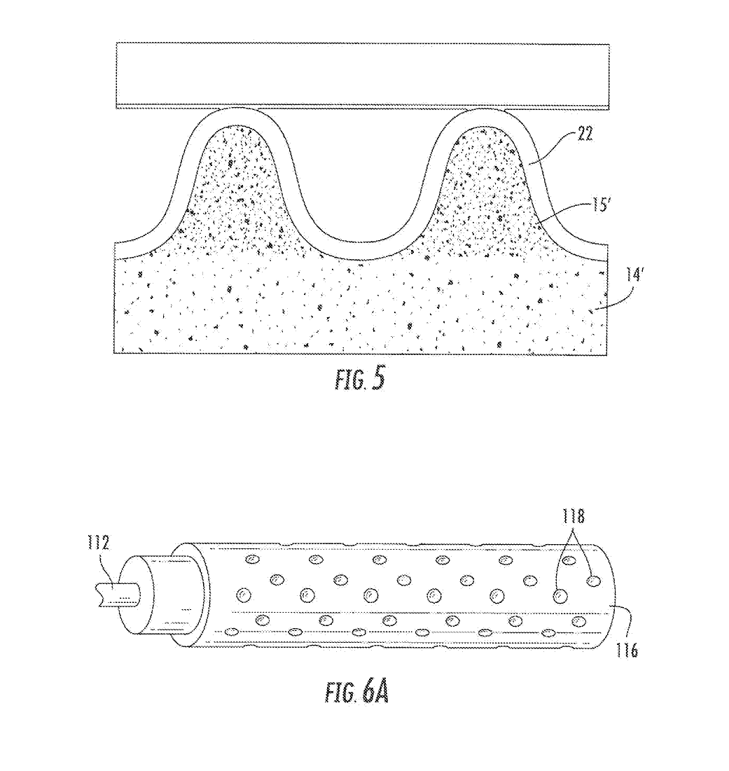

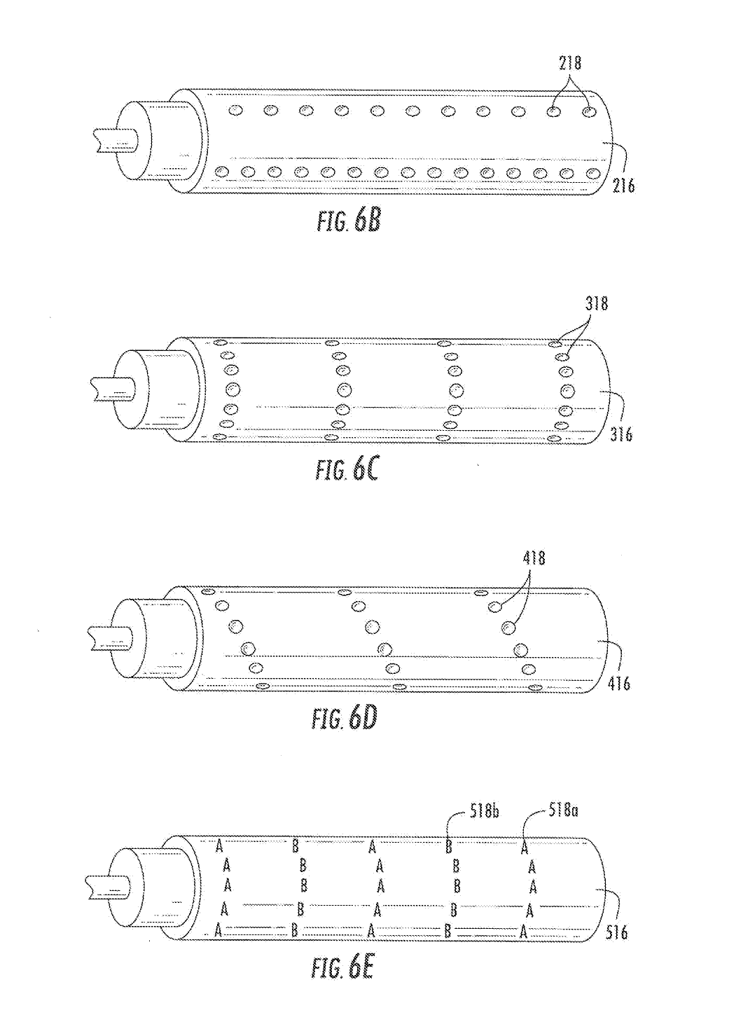

Referring now to the drawings, FIG. 3 shows an intermediate construction of a coaxial cable during manufacturing. The intermediate construction 10 includes an inner conductor (not shown in FIG. 3—shown at 112 in FIG. 6a), a dielectric layer 14 (typically foamed) circumferentially surrounding the inner conductor, and a smooth wall outer conductor 16 circumferentially surrounding the dielectric layer 14. An adhesive layer 18 is interposed between the dielectric layer 14 and the outer conductor 16 to weld these layers together.

The inner conductor 12 and dielectric layer 14 may be of conventional construction, The smooth wall outer conductor 16 is thin; the thickness of the outer conductor 16 may be below 0.065 inch, and in some embodiments between about 0.0025 and 0.007 inch, which is sufficiently thick to provide adequate electrical properties to the coaxial cable. In some embodiments, the outer conductor 16 may be formed of copper.

The intermediate construction 10 proceeds to a corrugation station, wherein corrugations 22 are formed in the outer conductor 16 (see FIG. 4). The corrugations 22 may be of conventional size and configuration. As can be seen in FIG. 4, as the corrugations 22 are formed, the inner surface of the outer conductor 16 remains adhered to the dielectric layer 14, such that protrusions 15 in the dielectric layer 14 fill in the inner spaces of the corrugations 22. A jacket 20 of conventional construction is then added to cover the outer conductor 16.

Because the outer conductor 16 is adhered to the dielectric layer 14, these layers form a composite structure with considerable strength. As such, the composite structure can provide the mechanical strength required for acceptable bending, crush and tensile loading performance for a coaxial cable which are typically not achievable with a thin outer conductor that is not adhered to the dielectric layer 14. This performance can be achieved with a much thinner (and therefore much less expensive) copper layer as the outer conductor 16.

As shown schematically in FIG. 5, in some embodiments the dielectric layer 14′ has a density gradient, such that the radially inward portion of the dielectric layer 14′ is denser than the radially outward portion. Such a construction may enable the dielectric layer 14′ to be more easily deformed during the formation of the corrugations 22. In addition, the lower density of the radially outward portion of the dielectric layer 14′ may enable the protrusions 15′ of the dielectric layer 14′ to maintain a desired dielectric constant when compressed.

Referring now to FIGS. 6a-6e, alternative configurations for the outer conductor are shown in which the corrugations are replaced with dimpled impressions, wherein the dimples form indentations in the dielectric layer. FIG. 6a illustrates an outer conductor 116 in which a plurality of dimples 118 are dispersed thereon in a random pattern. FIG. 6b shows an outer conductor 216 in which dimples 218 are impressed in a series of longitudinal rows. FIG. 6c illustrates an outer conductor 316 in which dimples 318 are formed in multiple circumferential rings. In FIG. 6d, an outer conductor 416 includes dimples 418 in a helical pattern, and in FIG. 6e, an outer conductor 516 has dimples 518a, 518b (represented by “A” and “B” in FIG. 6e) in a dual helical pattern. Other arrangements will be apparent to those of skill in this art.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A method of manufacturing a coaxial cable, comprising:
providing an intermediate construction for a coaxial cable comprising an inner conductor, a dielectric layer circumferentially surrounding the inner conductor, and a smooth outer conductor circumferentially surrounding and adhered to the dielectric layer; and
impressing corrugations into the outer conductor and corresponding protrusions in the dielectric layer.

2. The method defined in claim 1, wherein the outer conductor has a thickness of less than 0.065 inch.

3. The method defined in claim 2, wherein the outer conductor has a thickness of between 0.0025 and 0.007 inch.

4. The method defined in claim 1, wherein the dielectric layer is foamed.

5. The method defined in claim 4, wherein the dielectric layer has a density gradient that decreases with increasing radial distance from the inner conductor.

6. The method defined in claim 1, wherein outer conductor comprises copper.

7. The method defined in claim 1, wherein the protrusions of the dielectric layer fill the corrugations of the outer conductor.

8. A coaxial cable, comprising:
an inner conductor;
a dielectric layer circumferentially surrounding the inner conductor; and
an outer conductor circumferentially surrounding the dielectric layer, the outer conductor having a thickness of less than 0.065 inch;
wherein the outer conductor has corrugations and the dielectric layer has protrusions that fill the corrugations.

9. The coaxial cable defined in claim 8, wherein the outer conductor is adhered to the dielectric layer.

10. The coaxial cable defined in claim 8, wherein the outer conductor has a thickness of between 0.0025 and 0.007 inch.

11. The coaxial cable defined in claim 8, wherein the dielectric layer is foamed.

12. The coaxial cable defined in claim 8, wherein the dielectric layer has a density gradient that decreases with increasing radial distance from the inner conductor.

13. The coaxial cable defined in claim 8, wherein outer conductor comprises copper.

14. A coaxial cable, comprising:
an inner conductor;
a foamed dielectric layer circumferentially surrounding the inner conductor; and
an outer conductor circumferentially surrounding the dielectric layer,
wherein the outer conductor has corrugations and the dielectric layer has protrusions that fill the corrugations; and
wherein the dielectric layer has a density gradient that increases with radial distance from the inner conductor.

15. The coaxial cable defined in claim 14, wherein the outer conductor is adhered to the dielectric layer.

16. The coaxial cable defined in claim 14, wherein the outer conductor has a thickness of between 0.0025 and 0.007 inch.

17. The coaxial cable defined in claim 8, wherein outer conductor comprises copper.

18. A coaxial cable, comprising:
an inner conductor;
a dielectric layer circumferentially surrounding the inner conductor; and
an outer conductor circumferentially surrounding the dielectric layer, the outer conductor having a thickness of less than 0.065 inch;
wherein the outer conductor has impressed dimples.

19. The coaxial cable defined in claim 18, wherein the outer conductor is adhered to the dielectric layer.

20. The coaxial cable defined in claim 18, wherein the outer conductor has a thickness of between 0.0025 and 0.007 inch.
